(19) United States
(12) Patent Application Publication
(10) Pub. No.: US 2013/0038733 A1
(43) Pub. Date: Feb. 14, 2013

(54) NIGHT VISION SYSTEM FOR USE IN A VEHICLE

(71) Applicants: Gary Palmer, Carlsbad, CA (US); Jeffrey P. Kennedy, San Juan Capistrano, CA (US)

(72) Inventors: Gary Palmer, Carlsbad, CA (US); Jeffrey P. Kennedy, San Juan Capistrano, CA (US)

(73) Assignee: XENONICS HOLDINGS, INC., Carlsbad, CA (US)

(21) Appl. No.: 13/207,799

(22) Filed: Aug. 11, 2011

(51) Int. Cl. H04N 5/33; H04N 7/18

(52) U.S. Cl. 348/148; 348/E07.085; 348/E05.09

(57) ABSTRACT

A night vision system for use in a vehicle includes a night vision device configured as a handheld monocular device. A mount for coupling the night vision device to the vehicle includes a mounting plate configured for attachment at an attachment point in the interior of the vehicle, a coupling assembly coupled to the mounting plate and coupled to a quick release plate of a quick release mechanism, the coupling assembly configured to permit adjustment of orientation of a mounted night vision device in elevation and azimuth. The quick release mechanism is configured to allow one-handed removal of the night vision device from the mount. Image data captured by the night vision device may be communicated through a communications link to a display device in the vehicle.

### FIELD OF THE INVENTION

This application relates to night vision systems for vehicles.

### BACKGROUND OF THE INVENTION

Activities engaged in by law enforcement personnel during performance of their duties often occur during the nighttime hours. For example, unlawful activities often occur in low light conditions or darkness in an attempt by the perpetrators to avoid observation. To prevent crime and protect society, law enforcement officers perform surveillance and other activities during times of low light or darkness. Identification of an alleged suspect, and viewing the suspect in the act of unlawful activity is needed before an arrest may be made. Identification and witnessing the unlawful activity is difficult when the activity occurs in darkness.

Surveillance is often performed from inside a vehicle. The vehicle may be positioned at a location where crime occurs frequently, or where officers may have information leading them to believe that an unlawful activity is about to occur. It is desirable that the presence and location of the observing officer remain unknown to the subjects of the surveillance. However, the officer requires a clear and unobstructed view of the subjects. For this reason, unmarked vehicles are used. An unmarked vehicle may be parked near the surveillance area in a way that does not arouse suspicion of the subject. To provide improved vision at night, night vision devices may be used. However, night vision devices in the form of goggles, restrict the peripheral vision of the officer thereby resulting in decreased personal safety. In addition, when the vehicle needs to be operated, night vision goggles must be removed before the officer may operate the vehicle.

Once a suspect has been identified and observed in an illicit act, an arrest may be made. The suspect may flee to avoid arrest, at which time the officer must pursue the suspect. Pursuit may occur in a vehicle, for example, when the suspect attempts to escape by vehicle. However, the pursuit may occur on foot, or may evolve from a vehicle chase to a foot pursuit. For example, a suspect's vehicle may become disabled or cornered in a location where the suspect can go no further. When this occurs, the suspect may abandon the vehicle and flee on foot. The officer gains an advantage over the suspect during nighttime pursuits when the officer has night vision capabilities.

Law enforcement vehicles have become increasingly technologically advanced, possessing systems for processing and providing information to the officer through onboard computers and displays that may be remotely connected to a remote station through a communications link. A night vision system for use in a vehicle is therefore desired.

### SUMMARY

A night vision system for use in a vehicle includes a night vision device configured as a handheld monocular device having a self contained power source for portable operation, a lens for receiving and focusing visible and near infrared light, a photo detector for converting the focused light from the lens to image data, a processor for processing the image data received from the photo detector and an internal display for displaying the processed image data to a user. A mount for coupling the night vision device to the vehicle includes a mounting plate configured for attachment to an attachment point on the interior of the vehicle. For example, the mounting plate may be adapted for attachment to a windshield. According to an embodiment, at least one articulated joint provides freedom of movement to a mounted night vision device in elevation and azimuth. The at least one articulated joint may include a first ball and socket joint coupled to the mounting plate and further coupled to a second ball and socket joint through a socket arm. The second ball and socket joint is coupled to a ball head containing a third ball and socket joint and a locking mechanism for preventing movement of the third ball and socket joint. One or more of the ball heads also may include a friction control for allowing a user to selectively control an amount of frictional force applied to the third ball and socket joint, allowing a user to provide movement of the third ball and socket joint when a threshold level of force needed to overcome the applied frictional force is exceeded. A quick release mechanism has a first part permanently coupled to the mount and a second part permanently coupled to the night vision device, and is configured to be in mutual engagement and to disengage responsive to urging of a release by a one-handed linear motion of a user, to enable quick disengagement of the night vision device from the mount.

In an embodiment, the night vision device may be configured with an input/output port for sending data and/or receiving power from an external source. Image data captured and processed by the night vision device may be communicated through a communications link to a display device installed in the vehicle. The image data is received at the display device which may include a memory, a processor and an integrated display. The image data is transmitted via a communications link from the night vision device to the display device. The image data may be further processed at the display device before being displayed at the integrated display of the display device. For example, in an embodiment, the night vision device may be configured as a handheld monocular device that is mounted in an upside down orientation with respect to the mount. The night vision device sends inverted data image to the display device through the communication link. The display device includes a memory which stores software instructions that when executed by a processor, cause the processor to re-invert the inverted image data to output image data in the correct orientation for viewing. The corrected image data is then displayed on the integrated display of the display device.

In an embodiment, a night vision system for use in a vehicle includes a mount having a mounting plate configured for attachment to an attachment point within a passenger compartment of the vehicle; a night vision device configured as a handheld monocular device, having a self contained power source, a lens for receiving and focusing visible and near infrared light, a photo detector for converting the focused light to image data, a processor for receiving the image data from the photo detector and processing the received image data, an internal display for receiving the processed image data from the processor and displaying the processed image data to a user, and an input/output port for communicating the image data. The night vision device is coupled to the mount by a quick release mechanism having a first part permanently coupled to the mount and a second part permanently coupled to the night vision device, and configured to be in mutual engagement with one another and to disengage from one another responsive to urging of a quick release actuator by a one-handed linear motion of the user. The mount is configured to permit pan and tilt adjustment of the night vision device when engaged via the quick release mechanism. A display device in the vehicle has an input port configured to receive the image data from the night vision device, a second processor for processing the received image data, and a display for displaying the processed image data to the user; and a communication link between the input/output port of the night vision device and the input port of the display device for transmitting the processed image data from the night vision device to the display device.

### BRIEF DESCRIPTION OF THE DRAWINGS

FIG. 1A is an elevation view of a night vision system for use in a vehicle illustrating a mount and night vision device according to an exemplary embodiment;

FIG. 1B is a perspective view of the mount and night vision device of FIG. 1A;

FIG. 1C is a perspective view of a quick release mechanism for use in the night vision system of FIG. 1A for a vehicle;

FIG. 1D is an elevation view of a night vision system for use in a vehicle illustrating a mount and night vision device according to an exemplary embodiment;

FIG. 1E is a perspective view of a night vision system for use in a vehicle illustrating a mount and night vision device according to an exemplary embodiment;

FIG. 2 is a partially exploded view of the mount according to the embodiment shown in FIGS. 1A-1C;

FIG. 3 is an illustration of a night vision system for installation in a vehicle according to an exemplary embodiment;

FIG. 4 is a perspective view of a police patrol car in which a night vision system according to an exemplary embodiment is installed.

### DETAILED DESCRIPTION

Various embodiments may now be better understood with reference to the following detailed description which are presented as illustrated examples of the embodiments defined in the claims. It is expressly understood that the invention as defined in the claims may be broader than the illustrated embodiments described below. In the description of the embodiments, it will be recognized that some details may be omitted from the figures and the description. Details omitted from this specification are well known in the art and do not contribute to a better understanding of the invention and have therefore been omitted for the sake of clarity and conciseness. Inclusion of these details do not affect the intended scope of this description, as additional or substitution elements may be included an still fall within the spirit and scope of this

### DETAILED DESCRIPTION

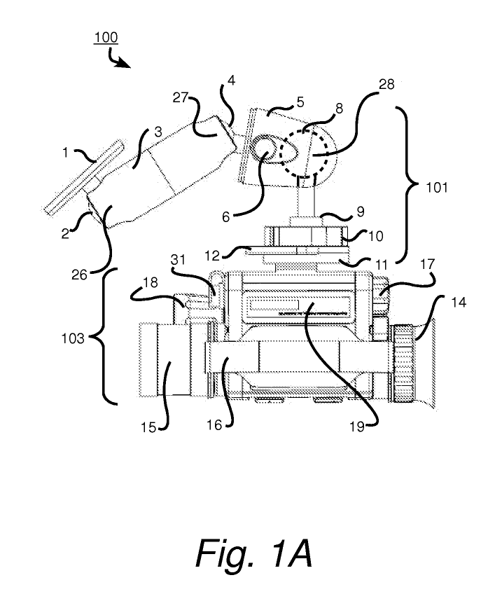

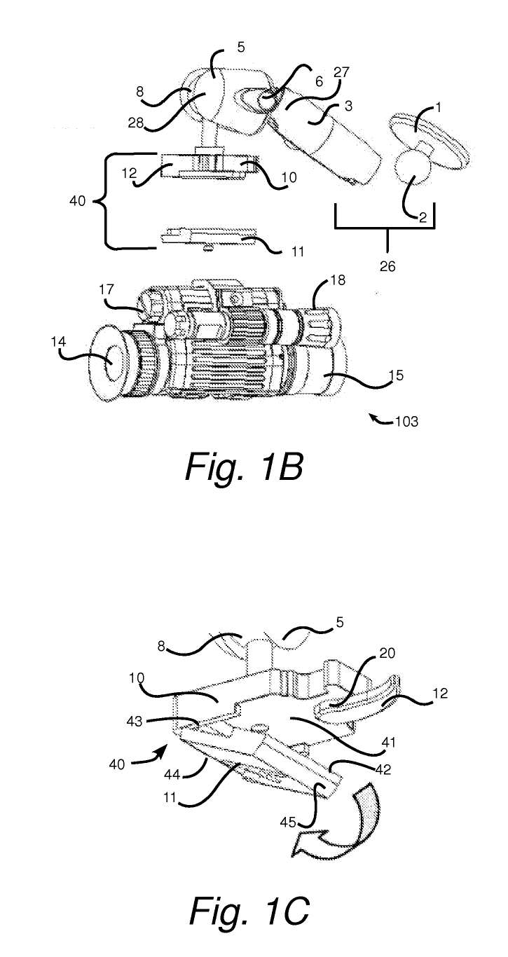

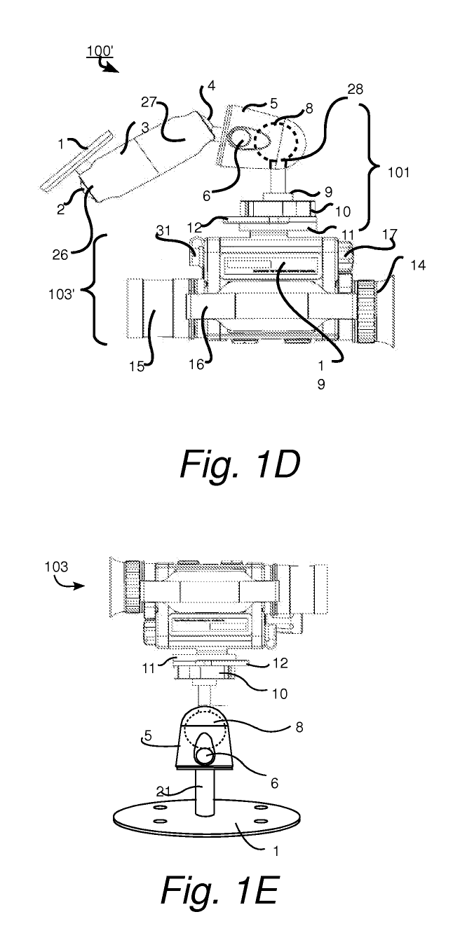

FIG. 1A shows an exemplary embodiment of a night vision system 100 for use in a vehicle including a mount 101 and a night vision device 103. The night vision device 103 may be a self contained unit which is operable to provide night vision capabilities as a handheld monocular night vision device. A hand strap 16 secures night vision device 103 in the hand of a user. The night vision device 103 may be configured with a self contained power source 17, such as, by way of example, a lithium ion rechargeable battery. The battery may be recharged by removing the battery from the night vision device 103 and placing the battery into an appropriate recharger. Alternatively, the night vision device 103 may be configured with an input port 31 which is configured to receive a power adapter plug which provides appropriate voltage to the night vision device 103 to charge the internal power source. Upon receiving electrical current through input port 31 that is sufficient to operate the night vision device 103, circuitry (not shown) within the night vision device 103 may be configured to utilize the supplied current to operate the night vision device 103. The received current may also be used to charge the self contained power source 17. For example, a cable may be connected to a 12 volt power socket provided in a vehicle, for example, a socket compliant with ANSI/SAE standard J563 for 12 volt cigar receptacles. Power is supplied from the vehicle's power distribution system to the socket and supplied to a compatible adapter plug inserted in the socket. The power is transmitted through the cable to an adapter plug that is configured to engage input port 31 and supply power to the night vision device 103.

The night vision device 103 includes a lens 15 having an aperture for receiving light in the visible and near infrared spectra. The lens 15 focuses the light on a photo detector (not shown) such as a charge coupled device (CCD) array. Other sensor technologies may be used such as complementary metal-oxide semiconductor (CMOS) sensors, or hybrid CCD/CMOS sensors, by way of non-limiting example. The embodiment described hereinafter references a CCD array, however it is understood that other sensor technologies, including other photodetector arrays, may be substituted for the CCD array. The CCD array generates image data based on the received and focused light which is reflected off of external objects within the field of vision of lens 15. The image data may be received and processed by an internal processor 19 in electrical communication with the photo detector. The processor 19 processes the received image data and performs digital signal processing to enhance or clarify the image data. For example, through digital signal processing, areas of varying contrast and edges delineating objects may be identified in the digital image data and enhanced for subsequent display. In addition to existing light, additional direct illumination may be provided to illuminate the field of view. A direct illumination source 18, for example an infrared illuminator, may be mounted on or incorporated in night vision device 103 to project infrared and/or near infrared light into the field of view of night vision device 103. Illumination source 18 results in infrared and/or near infrared light being reflected off of objects in a scene or the field of view of the night vision device 103, received by the lens 15, and focused on the photo detector for detection of the objects. As infrared and near infrared light is not visible to the unaided eye, persons in the scene will not perceive the illumination source 18 as a source of illumination and they are less likely to avoid detection.

Referring to FIG. 1D, an alternate embodiment of a night vision system 100′ is shown. Night vision system 100′ differs from the night vision system 100 of the embodiment of FIGS. 1A-1C only in that the night vision device 103′ of FIG. 1D does not include an illumination source. In the embodiment of FIG. 1D, night vision system 100′ includes a night vision device 103′ which receives ambient light reflected from a scene and which is not configured to provide direct illumination. The elements and functions of the embodiment shown in FIG. 1D are similar to the elements and functions described hereinabove with regard to FIG. 1A exclusive of the direct illumination source. Accordingly, the detailed description provided hereinabove with respect to FIG. 1A applies to like numbered elements of FIG. 1D and a detailed description of their function is omitted here for conciseness.

The processor 19 may be configured, upon processing the received image data, to send a signal containing the processed image data to an internal display 14 in electrical communication with processor 19. The internal display 14 is configured to display an image based on the enhanced image data from processor 19. An eyecup may be provided which a user may press against their eye for viewing the internal display 14.

The night vision device 103 may be configured for use in a vehicle according to an embodiment of a night vision system 100 by utilizing a mount 101 for coupling the night vision device 103 to the vehicle. The mount 101 includes a mounting plate 1 for attachment to an attachment point on the interior of the vehicle. Exemplary attachment points include the windshield of the vehicle, any of the side windows of the vehicle, including the front passenger vent window or a main front passenger side window, the surface of the padded dashboard of the vehicle, the ceiling of the passenger compartment of the vehicle, a door of the vehicle, a frame of the vehicle, the headliner of the vehicle, or another attachment point. For example, the configuration of the mounting plate 1 may be selected depending on the attachment point. For example, for attachment to a smooth surface, such as the windshield, the side window, or a planar or nearly planar portion of the dashboard, the mounting plate may be configured for attachment by being generally flat, optionally with a concave curve to contain quantity of a liquid adhesive. The mounting plate may also be configured for attachment by having one or more suction cups on the mounting plate. The mounting plate may also be configured for attachment by having bores defined therein for attachment using a mechanical fastener. For example, mounting plate 1 may be placed on a dashboard of the vehicle, and a mechanical fastener such as a screw, rivet or other fastener passing through a bore provided in the mounting plate and engaging a structural element of the vehicle. By way of example, the dashboard may include a metallic or plastic frame rigidly attached to the vehicle, and having mounted on the metallic or plastic frame foam padding and a covering of fabric or sheeting, made of materials such as leather or vinyl, on the padding. A fastener may be inserted into a bore in the mounting plate 1, passing through the covering and the padding to fasten the mounting plate 1 to the frame. According to an embodiment, the mounting plate may be attached to the interior of the vehicle on a window, on the dashboard, or mounted to the ceiling or headliner of the vehicle through an appropriate fastening method. For example, the mounting plate 1 may adhere to the windshield using an epoxy designed for use in an automotive glass application. In another embodiment, a suction cup may be attached to mounting plate 1 and provide attachment of the mounting plate by suction.

Mount 101 may include mounting plate 1 and an adjustment assembly configured to permit pan and tilt adjustment of a supported device, such as a night vision device. The adjustment assembly may include a single ball and socket joint, multiple ball and socket joints, or other combinations of joints, as explained by way of the examples below.

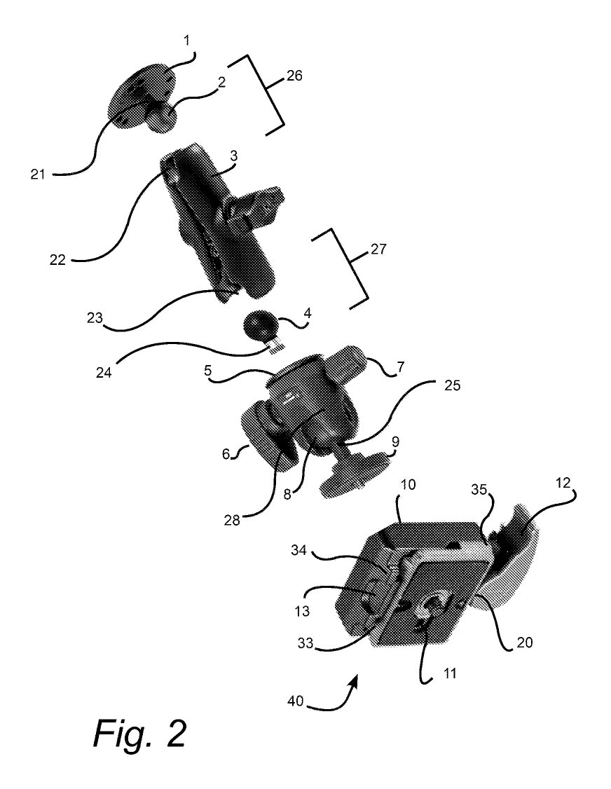

Referring again to FIG. 1A, a first ball 2 is rigidly attached by a shaft to mounting plate 1. First ball 2 is placed within one socket of socket arm 3 to define a first ball and socket joint 26. Double socket arm 3 includes two sockets (shown in FIGS. 2 as 22 and 23). First ball engages a first socket 22 of socket arm 3. A second ball and socket joint 27 is defined by the second socket 23 of socket arm 3 and a second ball 4 configured to engage the second socket 23. The first and second socket joints 26, 27 are joined by double socket arm 3 and provide a coarse positioning adjustment for the night vision device 103 when it is attached to a vehicle by mount 101. Using the first and second ball and socket joints 26, 27, an attached night vision device may be moved vertically and laterally in addition to rotationally. The user may select a position for the night vision device 103 such that the night vision device's 103 field of view includes any area viewable from within the vehicle. This allows the night vision device 103 to be positioned to avoid internal obstructions, for example, a windshield or roof post, or side view mirror.

Second ball 4 is rigidly coupled to a ball head 5 which together with ball 8 defines a third ball and socket joint 28. Ball head 5 is configured with a locking mechanism 6, which allows the user to tighten the locking mechanism 6 and prevent motion of third ball and socket joint 28. In addition, ball head 5 includes a friction adjustment (shown in FIG. 2 as 7). The friction adjustment 7 is configured to selectively apply, based on user adjustment, a frictional force or resistance to movement of the third ball and socket joint 28. The amount of selected friction acts to prevent movement of ball 8 when acted on by a force less than a threshold force which is determined by the selected amount of friction. If a force greater than the threshold force is applied to ball and socket joint 28, ball 8 will move within its socket. By way of example, the threshold force selected by the user via friction adjustment 7 may be sufficient to hold a night vision device 103 attached to mount 101 steady while the vehicle is in motion. However, when the vehicle is stopped, for example, during a surveillance operation, the user may grasp the night vision device 103 and adjust its position in elevation and azimuth by applying a force to ball 8 sufficient to overcome the threshold force and move the night vision device 103 to a desired position. This allows the night vision device 103 to be tilted in a manner which plumbs the night vision device 103 with respect to the mount position defined by the first and second ball joints.

The above described embodiment includes an arm having sufficient length to maintain the quick release mechanism and thus the night vision device at a sufficient distance from interior surfaces of the vehicle to permit adjustment of the night vision device through a 360 degree angle in azimuth, and to permit at least about 45 degrees angle of adjustment in elevation. Thus, the arm may be more than one-half the length of the longest dimension of the night vision device, and may be at least the length of the longest dimension of the night vision device.

The above described embodiment, having three ball and socket joints is provided by way of non-limiting example only. In other embodiments, other mounting structures which provide movement in elevation and azimuth of a mounted night vision device may be provided. For example, mounting plate 1 may be attached to a rigid arm or post having a ball joint at an opposite end to which a quick release mechanism is coupled. In another embodiment, a quick release mechanism may be coupled via a mount that includes two pivot joints, two hinges, or another structure to permit adjustment in elevation and azimuth. In another embodiment, an articulated joint may be provided. In other embodiments, a mounting structure may be provided in which the quick release mechanism is mount to provide adjustment in azimuth only. In still other embodiments, a mounting structure may be configured as a rigid rod to provide a fixed mount for a quick release mechanism. In all embodiments in which the orientation of the night vision device may be adjusted, the mounting mechanism may be configured with a suitable frictional joint so that each joint will retain its orientation when adjusted by the user notwithstanding the weight of the night vision device. The friction may also be selected so that each joint retains its orientation notwithstanding the motion of the vehicle. It will be appreciated that the reference to adjustment in azimuth and elevation is synonymous with adjustment in pan and tilt, respectively.

Ball 8 is coupled through a shaft 25 (shown in FIG. 2) to a threaded member 9 which engages a corresponding threaded opening in a quick release mechanism 40, for example, the quick release mechanism 40 illustrated in FIG. 1C. Quick release mechanism 40 includes quick release plate 10, shoe plate 11, and quick release actuator 12. Threaded member 9 engages quick release plate 10. Quick release plate 10 remains attached to mount 101 during operation of the night vision device 103 whether in combination with mount 101 while in a vehicle or during operation of the night vision device 103 as a handheld monocular. Shoe plate 11 remains attached to night vision device 103 during operation of the night vision device 103 whether in combination with mount 101 while in a vehicle or during operation of the night vision device 103 as a handheld monocular. Quick release plate 10 includes a mating surface 41 (shown in FIG. 1C) that faces shoe plate 11 and engages shoe plate 11 when the quick release mechanism 40 is in a engaged state, for example, when the night vision device 103 is being used in a vehicle.

Quick release actuator 12, which by way of example, may be embodied as a lever, retains shoe plate 11 in direct contact with quick release plate 10 when quick release actuator 12 is in a first position. Quick release actuator 12 may be spring loaded and biased to maintain quick release actuator 12 in the first position. To disengage the quick release mechanism 40 (i.e. detach shoe plate 11 from quick release plate 10), a user moves quick release actuator 12 to a second position which disengages a beveled edge 45 of shoe plate 11 from quick release actuator 12. The quick release actuator 12 is configured to return to its first position, securing shoe plate 11 and night vision device 103 to the quick release plate 10 and mount 101 when a user places the shoe plate 11 in direct contact with quick release plate 10 as is described in greater detail hereafter with regard to FIG. 1C.

Referring to FIG. 1B, shoe plate 11 is shown in isolation from the other components of night vision system 100. Shoe plate 11 may be configured to couple with night vision device 103 by, for example, a threaded bore designed for receiving a tripod mount, or some other attachment method. During operation, when the night vision device 103 is mounted in a vehicle, the night vision device 103 is coupled to shoe plate 11 which engages the quick release plate 10 which, in turn, is coupled to mount 101. When the user desires to use night vision device 103 as a handheld night vision monocular, the user applies force to quick release actuator 12. The night vision device 103 and attached shoe plate 11 become disengaged from quick release plate 10 and hence, the mount 101. The night vision device 103 may then be removed from the vehicle and used as a handheld monocular night vision device.

Referring to FIG. 1C, the operation of the quick release mechanism 40 will be described. Quick release plate 10 includes a generally planar mating surface 41 configured to mate with a complementary surface 42 of shoe plate 11. The mating surface 41 of quick release plate 10 is generally rectangular in shape. Along one edge of the mating surface 41, a ridge 43 is defined that rises above the plane defined by the mating surface 41. Ridge 43 may extend to a portion of the adjoining edges of quick release plate 10 to form a channel into which shoe plate may slide to provide alignment of shoe plate 11 when engaging quick release plate 10. A cleat 13 (shown in FIG. 2) extends from the ridge 43 to partially cover the mating surface 41 of quick release plate 10. When the shoe plate 11 is in engagement with the quick release plate 10, a first edge 44 of shoe plate 11 is configured to slide under cleat 13 and fit between cleat 13 and the mating surface 41 of quick release plate 10. To slide the shoe plate 11 under cleat 13, the shoe plate 11 may be held at a position defining an angle between the mating surface 41 of quick release plate 10 and the complementary surface 42 of shoe plate 11 with the first edge 44 closest to quick release plate 10. The first edge 44 is slid under cleat 13 as shown by the position illustrated in FIG. 1C. The shoe plate 11 is then rotated downward such that complementary surface 42 mates with mating surface 41. On the edge of shoe plate 11 opposite the first edge 44, a beveled edge 45 provides a surface which a portion 20 of quick release actuator 12 comes in contact with when the quick release actuator 12 is in a first position. Ball 8 is shown within its ball and socket joint 28 defined by ball head 5. Quick release plate 10 is coupled to a shaft 25 (shown in FIG. 2) extending from ball 8. The quick release plate 10 remains coupled to mount 101 whether a night vision device 103 is attached to mount 101 or whether the night vision device 103 has been removed from the mount 101 to be used as a handheld monocular night vision device. Quick release plate 10 includes a spring loaded quick release lever 12 movably coupled to quick release plate 10 which serves as an illustrative actuator for the quick release mechanism 40.

Shoe plate 11 is coupled to night vision device 103, for example, through a threaded bore provided in housing of night vision device 103 to accommodate, by way of example, a tripod. Shoe plate 11 remains coupled to the night vision device 103 in all modes of operation such as when night vision device 103 is used in combination with mount 101 while in a vehicle, or when night vision device 103 is used as a handheld monocular independent of mount 101. Shoe plate 11 is coupled to night vision device 103 and also to the quick release plate 10 when the night vision device 103 is used in a vehicle. When the night vision device 103 is detached from mount 101 to be used as a handheld device, the shoe plate 11 detaches quickly and easily from quick release plate 10 while remaining coupled to the night vision device 103.

To operate the quick release mechanism 40 to disengage night vision device 103 from mount 101, the user rotates the quick release actuator 12 from a first position to a second position. In the first position, a portion 20 of the quick release actuator 12 engages the beveled edge 45 of shoe plate 11 providing a force which retains shoe plate 11 in direct contact with quick release plate 10. A spring force applied to the quick release actuator 12 provides a bias to retain quick release actuator 12 in the first position as a default. When a user moves quick release actuator 12, using a one-handed linear motion, from the first to the second position, the portion 20 of quick release actuator 12 is no longer in contact with the beveled edge 45 of shoe plate 11.

While in the second position, the portion 20 of quick release actuator 12, which engages the beveled edge 45 of shoe plate 11, is moved to a position where it is no longer in contact with the beveled edge 45 of shoe plate 11. When quick release actuator 12 is in the second position, the beveled edge 45 of shoe plate 11 may be disengaged from quick release plate 10 and moved away from quick release plate 10 in a direction indicated by the arrow shown in FIG. 1C. The edge 44 of shoe plate 11 opposite the beveled edge 45 shown in FIG. 1C, shown engaging cleat 13 (shown in FIG. 2) may be slid out from under cleat 13 allowing the shoe plate 11 to be detached from quick release plate 10 completely. The quick release plate 10 may be configured with a spring loaded stop (not shown) which presses against the lower surface of quick release actuator 12 (relative to quick release plate 10). Quick release actuator 12 includes a recess (not shown) in its underside that aligns with the spring loaded stop when the quick release actuator 12 is moved to the second position. When the recess in quick release actuator 12 aligns with the stop, the stop is pressed upward due to the force of the spring and is inserted into and engages the recess to retain the quick release actuator 12 in the second position.

To reattach shoe plate 11 (and night vision device 103 attached thereto) to quick release plate 10, the edge 44 of shoe plate 11 which engages cleat 13 is slid into position under cleat 13 as illustrated in FIG. 1C. The opposite edge (the beveled edge 45 visible in FIG. 1C) is then swung to bring the complementary surface 42 of shoe plate 11 in direct contact with the mating surface 41 of quick release plate 10. A portion of the spring loaded stop that holds quick release actuator 12 in its second position (i.e. a disengaged position) is exposed on a area of the mating surface 41 of quick release plate 10 that contacts the complementary surface 42 of shoe plate 11. Thus, when shoe plate 11 is swung into an engaged position, the complementary surface 42 of the shoe plate 11 depresses the stop and causes the stop to withdrawal and disengage from the recess in quick release actuator 12. The bias applied by the spring force on quick release actuator 12 returns the quick release actuator 12 to its first position. In its first position, a portion 20 of quick release actuator 12 contacts the beveled edge 45 of shoe plate 11 retaining shoe plate 11 in direct contact with quick release plate 10. According to an embodiment, an operator engages the quick release mechanism 40 for use of the night vision device 103 in a vehicle engaging the first edge 44 of shoe plate 11 under cleat 13 and swinging shoe plate 11 into an engaged position which automatically depresses the stop, releasing quick release actuator 12 from the second position and returning it to the first position, thereby retaining shoe plate 11 in direct contact with quick release plate 10.

To disengage the night vision device when installed in a vehicle, the operator simply performs the one-handed linear operation of rotating quick release actuator 12 to its second position. The shoe plate 11 disengages from the quick release plate 10 allowing the night vision device 103 and shoe plate 11 to be removed by swinging shoe plate 11 to the position illustrated in FIG. 1C and sliding the edge engaging cleat 13 out from under cleat 13. It is further noted that in an embodiment of night vision system 100, quick release plate is mounted in a suspended orientation. That is, the mating surface of quick release plate 10 faces downward and shoe plate 11 (and the night vision device 103) are suspended from it. In this position, the shoe plate 11 and attached night vision device 103 hang from the quick release plate 10 such that when the quick release mechanism 40 is operated to disengage the night vision device 103, the mass of the night vision device 103 and shoe plate 11 is sufficient to cause the night vision device 103 and shoe plate 11 to fall from the quick release plate 10 due to the force of gravity. Thus, a user, for example, a law enforcement officer about to engage in a foot pursuit, may position his or her hand below the night vision device 103, and operate the quick release actuator 12 with the same hand. The night vision device 103 drops into the officer's hand and is ready for use as a handheld device.

While the foregoing embodiment illustrates the use of a quick release lever as an actuator 12 for operating the quick release mechanism 40, other types of actuators may be used that provide the user with a one-handed, simple linear motion that disconnects shoe plate 11 from quick release plate 10. By way of a non-limiting example, a slider, toggle, pull, or pushbutton may be used to perform an equivalent function. One skilled in the art may contemplate other mechanisms for performing equivalent functions.

Referring now to FIG. 1E, another embodiment of a night vision system for use in a vehicle is shown. Night vision device 103 is coupled to shoe plate 11 which is engagably coupled to quick release plate 10. Shoe plate 11 may be disengaged from quick release plate 10 by a user urging actuator 12 from a first to a second position. Quick release plate 10 is coupled to a ball 8 which, together with ball head 5, defines an articulated joint. A locking mechanism 6 selectively prevents movement of ball 8 within ball head 5 and allows a user to lock the night vision device 103 is a desired position and orientation. The articulated joint defined by ball head 5 and ball 8 is coupled directly to mounting plate 1 through shaft 21. The articulated joint allows movement of night vision device 103 in azimuth (pan) and/or elevation (tilt). Mounting plate 1 is adapted for attachment to an attachment point on the interior of the vehicle, for example, a windshield, window, dashboard, frame, ceiling, headliner or other suitable structure. Other available attachment points may be selected that provide a desired field of view for night vision device 103. While ball head 5 and ball 8 define a ball and socket joint in the embodiment illustrated in FIG. 1E, other articulated joints may be used which provide movement of the night vision device 103 in elevation and azimuth. These may include, but are not limited to, an articulated joint provided by a rotating pin, pivot, hinge, slotted channel or other structure for providing relative movement between night vision device 103 and mounting plate 1.

Referring now to FIG. 2, an exploded view of the mount 101 described in FIG. 1A-1C is shown. Mounting plate 1 is configured for attachment to a windshield of the vehicle. In an embodiment, mounting plate 1 may have a generally flat or slightly convex surface with a circumferential lip to define a shallow well. The shallow well may be filled an automotive epoxy which permanently attaches mounting plate 1 to the windshield. In another embodiment, mounting plate 1 may be coupled to a suction cup which when pressed against the windshield creates a vacuum which holds the suction cup and attached mounting plate 1 to the windshield. Other attachment structures and methods may be contemplated by a person skilled in the art which would also fall within the scope of this disclosure. A first ball 2 is rigidly coupled to mounting plate 1 through a shaft 21. First ball 2 engages a socket 22 in a first end of a double socket arm 3 defining first ball and socket joint 26. Ball 4, is rigidly attached via shaft 24 to ball head 5. Ball 4 engages socket 23 to define a second ball and socket joint 27. A tightening mechanism is provided to allow simultaneous tightening of first ball and socket joint 26 and second ball and socket joint 27 to prevent movement of the first and second ball and socket joints 26,. Night vision device 103 while attached to mount 101 may be set in a position selected by the user by positioning the night vision device 103 which causes ball 2 and 4 to move within their respective sockets 22, 23. When a desired position for the night vision device 103 is achieved, socket arm 3 is tightened, simultaneously tightening the first and second ball and socket joints 26, 27 to prevent the mount 101 from moving from the selected position. These ball and socket joints 26, 27 allow for coarse adjustment of the mount 101 for positioning the night vision device 103 in a desired position and direction. Ball head 5 includes a third ball and socket joint 28 which provides additional adjustments of elevation and azimuth for fine adjustment of the night vision device's 103 position. For example, using the third ball and socket joint 28 of ball head 5, a night vision device may be positioned to be plumb for any position defined by the first and second ball and socket joints 26, 27.

Ball head 5 includes a lock mechanism 6 for allowing a user to selectively prevent movement of ball and socket joint 28. In addition, ball head 5 includes a friction adjustment 7 for applying a configurable amount of friction force to ball and socket joint 28. Friction adjustment 7 allows a user to selectively adjust the position of night vision device 103 using ball and socket joint 28. The user grasps the night vision device 103 and applies an amount of force sufficient to overcome the applied friction force. This allows the user to move ball and socket joint 28 to adjust the night vision device's 103 position in elevation and azimuth as desired.

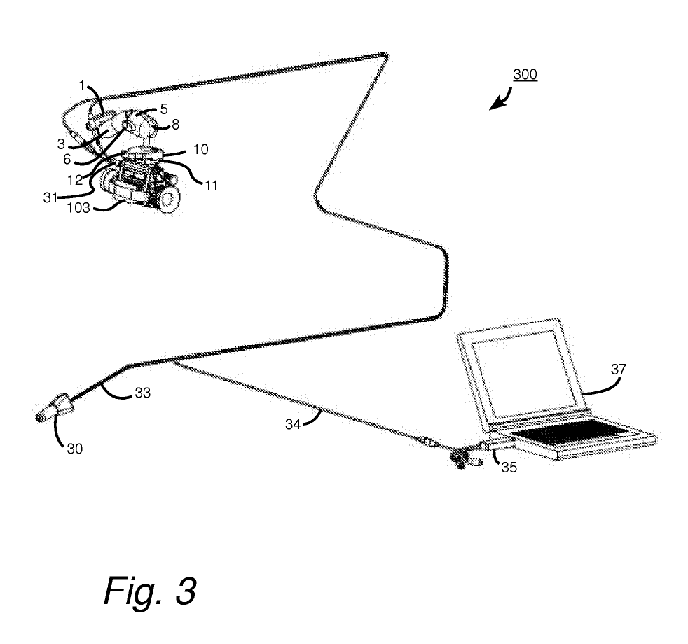

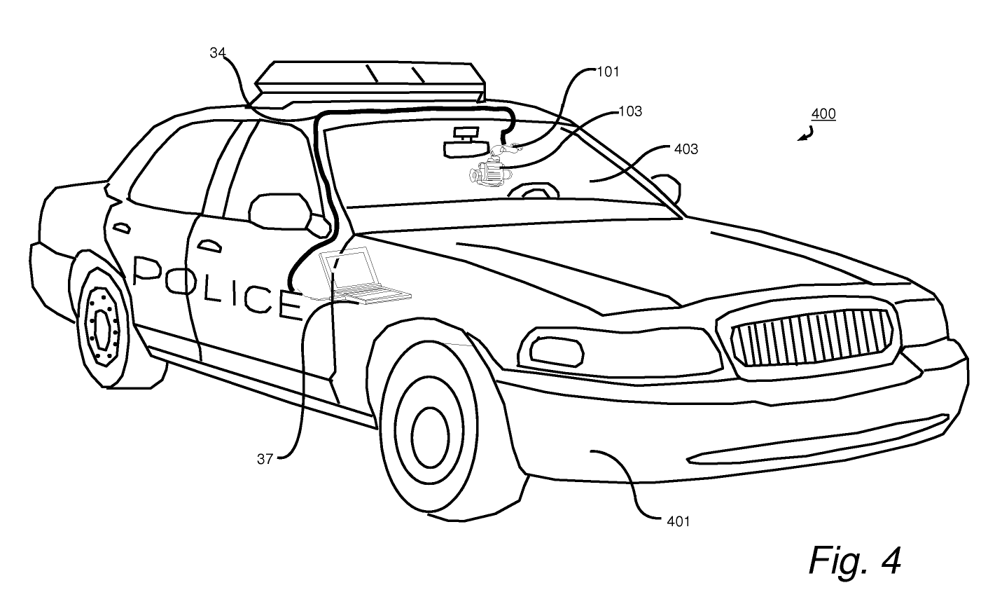

Ball 8 is coupled to a threaded member 9 by shaft 25. Shaft 25 allows the mount 101 to be coupled to quick release plate 10. Quick release plate 10 includes a cleat 13 and a quick release actuator 12. The quick release plate 10 operates as described above with respect to FIG. 1C. Shoe plate 11, shown in FIG. 2 in an engaged state, is in direct contact with quick release plate 10 and retained in an engaged position by quick release actuator 12. The shoe plate 11 may be coupled to the night vision device 103 through a compatible mount, for example, a threaded bore in the housing of night vision device 103 configured for attachment of a tripod. Due to the orientation of mount 101 (i.e., suspended from a surface such as a windshield), combined with the fact that a typical tripod mount is provided on the bottom surface of a night vision device 103, the night vision device 103 may be installed in an inverted position when attached to mount 101. Additional image processing may be provided to process the inverted image data from night vision device 103 for display as will now be described in reference to FIG. 3.

Referring to FIG. 3, a night vision system 300 for use in a vehicle is shown. Night vision system 300 includes a night vision device 103 configured as a handheld monocular for self contained operation independent of the vehicle mounted night vision system 300. The night vision device 103 is coupled to shoe plate 11 of a quick release mechanism 40 further including a quick release plate 10 and a quick release actuator 12. The act of operating the quick release actuator 12 by a user results in the shoe plate 11 and attached night vision device 103 detaching from quick release plate 10 allowing use of the night vision device 103 as an independent handheld device.

Quick release plate 10 is coupled to mount (shown in FIG. 1A as 101) which is configured for attaching night vision device 103 to the vehicle. Mount 101 includes a plurality of articulated joints for positioning an attached night vision device 103. Joints are configured to provide user selected placement of night vision device 103 relative to the windshield on which mount 101 is attached to achieve a desired field of view. Ball and socket joint 28 further provides positioning of night vision device 103 in elevation and azimuth to allow for fine adjustment of the night vision device's 103 position. In the illustrated embodiment of FIG. 3, ball 8 defines a ball and socket joint 28 (shown in FIG. 2) with a socket formed in ball head 5. Ball head 5 includes a locking mechanism 6 for selectively preventing movement of ball and socket joint 28. When night vision device 103 is placed in a position which provides the desired field of view, the locking mechanism 6 may be tightened to prevent movement of the night vision device 103 relative to mount 101. A double socket arm 3 defines sockets 22, 23 (shown in FIG. 2). Sockets 22, 23 along with ball 2 and 4 as described with respect to FIG. 2, define first and second ball and socket joints 26, 27 that provide coarse position adjustments for night vision device 103. Mounting plate 1 is configured for attachment to a surface within the vehicle. For example, mounting plate 1 may be affixed to a windshield of the vehicle. Mounting plate 1 may be affixed permanently to the windshield using epoxy or another suitable adhesive designed for automotive glass applications. Other attachment structures, for example a suction cup, may be used, provided the structure allows for a secure attachment of night vision device 103 to the vehicle.

It should be noted that a vehicle used for law enforcement may be subject to extraordinary forces. Forces resulting from sudden acceleration, braking or steering may be transmitted from the vehicle to the mount 101 and night vision device 103. To prevent the mount 101 from becoming detached and moving within the vehicle, possibly striking an occupant of the vehicle, the attachment structure should account for such forces, i.e. epoxy to attach mount to windshield, ruggedness of mount joints, and robustness of the quick release mechanism should be designed to ensure mount 101 is securely attached to the vehicle.

Night vision device 103 may be configured with an input/output port 31 for sending and/or receiving data signals or receiving power. For example, power may be provided by the vehicle via a cigar lighter socket through a cigar lighter socket plug 30. Socket plug 30 may be a plug compliant with the ANSI/AES J563 standard for 6 and 12 volt cigar lighter receptacles. The vehicle's electrical power distribution system provides, for example, 12 volt direct current (DC) power via socket plug 30 through power cable 33 to an adapter plug configured to engage input/output port 31 and provide 12 volts DC power to night vision device 103. The received power may be used to provide operating voltage to the night vision device 103. Alternatively, the received power may be used to charge an internal power source (FIG. 1A, 17) such as a rechargeable battery. While connected to the vehicle via mount 101 and connected to power cable 33, the night vision device 103 may receive input power through power cable 33. In an embodiment, input power is sufficient to run the night vision device 103, thereby allowing the night vision device 103 to operate without the need to draw current from for the internal power source 17. Moreover, the night vision device 103 may use a portion of the input power supplied by the vehicle to charge its internal power source 17 while night vision device 103 is connected to the vehicle. In the event the night vision device 103 no longer receives power via power cable 33, is removed from the mount 101 (e.g., the vehicle's electrical system is off, or the night vision device 103 has been disconnected from the power cable 33), the internal power source 17 will be charged and prepared to provide power sufficient to operate the night vision device 103 as a handheld monocular device. In addition to receiving power, input/output port 31 may be configured to send image data from night vision device 103 via data communication cable 34 to a display device 37. Data communication cable 34 is coupled at one end to input port 35 communicatively coupled to display device 37 which is installed in the vehicle. Display device 37 includes an internal display 38 for displaying image data to a user. The display device 37 may be integrated in the vehicle, including a display 38 installed into the dashboard of the vehicle. In another embodiment, display device 37 may be a notebook or tablet computer operably connected to the vehicle and/or the night vision device 103 including an associated internal display 38. Other devices, such as smart phones, having processors and displays may be configured to receive and display image data. The illustrations herein are provided purely by way of non-limiting example. Other display devices 37 may be contemplated that display image data received from night vision device 103 to user.

Display device 37, for example, may be a keyboard display terminal (KDT) communicatively coupled to a central processing computer, installed in a location of the vehicle separate from the operator. For example, the central processing computer may be installed in the trunk of the vehicle and be communicatively coupled to the KDT installed in the passenger compartment where the KDT is visible to the vehicle operator. In an embodiment, image data may be transmitted from the night vision device 103 via communication cable 34 to input port 35 installed in the central processing computer. A processor within the central processing computer may receive the image data and perform further processing to the image data. The processed image data may be communicated from the central processing computer to a display 38 integral to the KDT by a suitable interface. The processed image data is displayed to the user at the display 38 integrated as part of the KDT.

In an alternative embodiment, image data transmitted from the night vision device 103 may be transmitted via input/output port 31 and communication cable 34 to a display 38 integral to the KDT. The transmitted image data may be received by the display 38 of the KDT without transmission to or processing by the central processing computer. Image data processed internally by the processor of the night vision device 103 may be displayed on the display 38 integrated as part of the KDT. In this embodiment, the KDT includes an appropriate interface and input port 35 for receiving image data from the night vision device 103 via communication cable 34. The image data may be transmitted from the KDT to the central processing computer for further processing, storage or other purposes.

As is described above with regard to FIGS. 1A-1C, the night vision device 103 may be installed in an upside-down orientation to utilize available attachment points, such as a tripod mount. For this reason, display device 37 may be configured to invert received image data from night vision device 103. By way of example, the orientation of night vision device 103 with respect to mount 101, may provide inverted image data to display device 37. The inverted data image is transmitted via input/output port 31 through data cable 34 to input port 35 of display device 37. Display device 37 receives the inverted data image and again inverts the received inverted image data in order to render the related image in its correct orientation. The righted image data is then provided to display 38 which displays the image data in its correct upright orientation to a user viewing display 38.

Further processing may be performed by a processor executing instructions embodied in software stored in a memory device of display device 37. The memory device may include a non-transitory computer readable medium on which processor executable instructions are stored, including e.g. magnetic hard drives, optical drives, flash memory, read-only memory (ROM), random access memory (RAM), PROMs, EEPROMS and other forms of memory devices. For example, software instructions may be stored in the memory device which cause a processor to receive and process image data from the night vision device 103 and perform a zoom function on the image data. The zoom function may crop a sub-area of the image data and zoom the cropped area to fill the display 38. The image data of the cropped area, after the cropping and zooming steps, is zoomed image data. In an embodiment, a memory device of display device 37 may store software instructions for receiving image data from night vision device 103 and storing the received data in a portion of memory device within display device 37. The stored image data may be representative of a still image. Furthermore, the stored image data may contain a series of video frames each representative of a still image. When the series of still images are combined, the chronological sequence provides a moving video image.

The embodiment shown in FIG. 3 depicts a communication link comprising input/output port 31, power cable 33, data cable 34 and input port 35. While the illustrated embodiment includes cables installed in the vehicle, other types of communication links may be used. For example, cables may be installed within the ceiling headliner, under trim, or by other methods. In another embodiment, a wireless link may be used to communicate between the input/output port 31 of night vision device 103 and the input port 35 of display device 37. For example, communications between input/output port 31 and input port 35 may be established through a BLUETOOTH® or WiFi™ link compliant with IEEE standard 802.11.

Communication between the night vision device 103 and the display device 37 may be one-way communication or two-way communication. In an embodiment using one-way communication, the input/output port 31 of night vision device 103 operates in a transmit only mode. Image data processed by the night vision device 103 is transmitted via input/output port 31 to display device 37 which receives the image data via input port 35. For two-way communications, input/output port 31 includes both transmit and receive modes of operation. Similarly, input port 35 of display device 37 is configured as an input/output port configured to either send or receive data. In two-way communications, night vision device 103 and display device 37 may exchange image data (or other data, e.g., control signals) between night vision device 103 and display device 37 in either direction. Display device 37 may communicate wirelessly with a remote station. For example, display device 37 may further be configured to allow input port 35 to communicate with other devices in addition to night vision device 103. For example, input port 35 may include a wireless transmitter and receiver configured to communicate with a remote station, such as a dispatch center, a mobile or fixed command station, another vehicle, a data center or other remote location. Input port 35 provides image data or other data to the remote station which may be configured to display image data received from the display device 37. Remote station may be further configured to receive data from display device 37 and store the received data on an available memory device. For example, still images or video data may be received at the remote station and saved to a memory device at the remote station for preservation as evidence. Wireless communications between display device 37 and the remote station may include, but are not limited to, satellite or cellular communications. Image data captured and displayed at the vehicle may be shared in real time with the remote station.

FIG. 4 is an illustration of the night vision system 300 of FIG. 3 installed in a vehicle 401 according to an exemplary embodiment. A police patrol car is shown with a night vision system 300 installed in the vehicle 401. The vehicle may be a marked patrol car as illustrated in FIG. 4. Alternatively, other vehicles may have the night vision system 300 installed. For example, vehicle 401 may be a van, truck, unmarked vehicle, sport utility vehicle (SUV) or any other vehicle capable of utilization by law enforcement.

A mount 101 is configured for attachment to the windshield 403 of vehicle 401. A night vision device 103 configured as a handheld monocular night vision device 103 is coupled to the mount 101 by a quick release mechanism 40. The quick release mechanism 40 includes a quick release plate (shown in FIG. 1C, 10) that remains coupled to mount 101, and a shoe plate (shown in FIG. 1C, 11) that is coupled to night vision device 103. When night vision device 103 is mounted in vehicle 401, shoe plate 11 is maintained in direct contact with quick release plate 10. When the user operates quick release lever (shown in FIG. 1C, 12) using a one-handed linear motion, shoe plate 11 disengages from quick release plate 10 and provides removal of night vision device 103 and shoe plate 11 from mount 101.

Night vision device 103 includes an input/output port (shown in FIG. 1A, 31) which provides a communications node for communications link 34 which provides transmission of image data between night vision device 103 and display device 37 installed in the vehicle 401. Communications link 34 may be in the form of a data cable run through the vehicle 401. For example, data cable 34 may be run under the ceiling headliner, through the windshield post and dashboard to display device 37. Display device 37, by way of example, may be an installed computer (i.e. integrated into the dashboard of the vehicle 401), a notebook or tablet computer, or other device suitable for displaying image data received from night vision device 103. Display device 37 may be located remotely from the vehicle and configured to receive image data from night vision device 103 by a communications link, for example a wireless communications link may be used. Display device 37 may be configured with a memory device and a processor. Memory of display device 37 may contain software instructions that are executable by the processor. The software instructions provide the processor instructions for further processing of image data received from night vision device 103. For example, night vision device 103 may be installed on mount 101 such that the night vision device 103 is suspended from mount 101 in an upside-down orientation. The night vision device 103, provides inverted image data to display device 37 via communications link 34. To provide an image representative of the inverted image data, the memory device may contain software instructions which when executed by a processor, process the inverted image data and render the image data in a righted orientation. The corrected image data may be displayed at an internal display (shown in FIG. 3, 38) integrated as part of display device 37.

Although the present invention has been set forth in terms of the embodiments described herein, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the present invention be interpreted as encompassing all alterations, modifications, or alternative applications as fall within the true spirit and scope of the invention.

What is claimed is:

1. A night vision system for use in a vehicle comprising:
a night vision device configured as a handheld monocular device, having a self contained power source, a lens for receiving and focusing visible and near infrared light, a photo detector for converting the focused light to image data, a processor for receiving the image data from said photo detector and processing the received image data, and an internal display for receiving the processed image data from the processor and displaying the processed image data to a user;
a mount comprising:
a mounting plate configured for attachment to an attachment point inside the vehicle; and
an adjustment assembly coupled to the mounting plate and comprising at least one joint and configured to provide movement of said night vision device in elevation and azimuth; and
a quick release mechanism comprising:
a shoe plate coupled to said night vision device;
a quick release plate coupled to said mount; and
a quick release actuator movably coupled to said quick release plate,
wherein said quick release plate and said shoe plate are configured to be in mutual engagement with one another and to disengage from one another responsive to urging of said quick release actuator by a one-handed linear motion of the user.

2. The night vision system of claim 1, wherein said adjustment assembly comprises a first articulated joint comprising a first ball and socket joint and a second articulated joint comprising a second ball and socket joint, said first and second ball and socket joints coupled to one another by a socket arm.

3. The night vision system of claim 2, wherein said adjustment assembly further comprises a third articulated joint comprising a ball head coupled to said second articulated joint, said ball head having a third ball and socket joint and a friction adjustment configured to selectively apply a frictional force to said third ball and socket joint.

4. The night vision system of claim 1, wherein said self contained power source is a rechargeable battery.

5. The night vision system of claim 1, further comprising an infrared illuminator rigidly mounted on a housing of said night vision device.

6. The night vision system of claim 1, wherein said night vision device further comprises a hand strap for securing said night vision device to a user's hand.

7. The night vision system of claim 1, wherein said attachment point is on a windshield of said vehicle, and the mounting plate is configured for adhesive attachment to the windshield.

8. The night vision system of claim 1, wherein said attachment point is on a side window of said vehicle, and the mounting plate is configured for adhesive attachment to the side window.

9. The night vision system of claim 1, wherein said attachment point is on a dashboard of said vehicle.

10. The night vision system of claim 1, wherein said attachment point is on a ceiling of said vehicle.

11. The night vision system of claim 1, wherein said adjustment assembly is coupled to said mounting plate by a rigid rod.

12. The night vision system of claim 1, wherein said joint comprises at least one ball and socket joint.

13. A night vision system for use in a vehicle comprising:
a mount having a mounting plate configured for attachment to an attachment point within a passenger compartment of the vehicle;
a night vision device configured as a handheld monocular device, having a self contained power source, a lens for receiving and focusing visible and near infrared light, a photo detector for converting the focused light to image data, a processor for receiving the image data from said photo detector and processing the received image data, an internal display for receiving the processed image data from the processor and displaying the processed image data to a user, and an input/output port for communicating the image data;
wherein said night vision device is coupled to said mount by a quick release mechanism having a first part permanently coupled to said mount and a second part permanently coupled to said night vision device, and configured to be in mutual engagement with one another and to disengage from one another responsive to urging of a quick release actuator by a one-handed linear motion of the user;
wherein said mount is configured to permit pan and tilt adjustment of the night vision device when engaged via the quick release mechanism;
a display device within the vehicle having an input port configured to receive the image data from said night vision device, a second processor for processing the received image data, and a display for displaying the processed image data to the user; and
a communication link between the input/output port of said night vision device and the input port of said display device for transmitting the processed image data from said night vision device to said display device.

14. The night vision system of claim 13, wherein said communications link comprises a cable coupled to the input/output port of said night vision device and the input port of said display device.

15. The night vision system of claim 14, wherein said communications link further comprises a power cable coupled between a power socket of the vehicle and said input/output port of said night vision device.

16. The night vision system of claim 13, wherein,
said second part of said quick release mechanism comprises a shoe plate; and
said first part of said quick release mechanism comprises a quick release plate and said quick release actuator movably coupled to said quick release plate, wherein the quick release plate and the shoe plate are configured to be in engagement with one another and to disengage from one another responsive to the urging of said quick release actuator.

17. The night vision system of claim 16, wherein said display device comprises a memory device having processor executable instructions stored thereon, the instructions when processed by the processor of said display device, cause the processor to render inverted the image data received by said display device in a righted orientation for viewing at said display of said display device.

18. The night vision system of claim 17, wherein said display device further comprises software instructions that when executed by said processor cause the processor to perform a zoom function of received image data and display the zoomed image data at said display.

19. The night vision system of claim 17, wherein said display device further comprises software instructions that when executed by the processor cause the processor to store said received image data in said memory device.

20. The night vision system of claim 13, wherein said communications link is a wireless communications link.

21. The night vision system of claim 20, wherein said wireless communications link is configured to transmit control signals from said display device to said night vision device.

22. The night vision system of claim 20 wherein said wireless communications link is configured to transmit data signals from said display device to a remote station.

23. The night vision system of claim 13, wherein said display device is a computer installed in said vehicle, having a display integrated in a dashboard of said vehicle.

24. The night vision system of claim 13, wherein said display device is a notebook computer communicatively coupled to said vehicle and having an integrated display.
